(19) United States
(12) Patent Application Publication
(10) Pub. No.: US 2013/0081577 A1
(43) Pub. Date: Apr. 4, 2013

(54) MUSICAL SCRATCHING TOY FOR HOUSEHOLD PETS

(71) Applicant: Robert Randall Morris, Chicago, IL (US)

(72) Inventor: Robert Randall Morris, Chicago, IL (US)

(73) Assignee: Lucky Litter LLC, Chicago, IL (US)

(21) Appl. No.: 13/645,290

(22) Filed: Oct. 4, 2012

Related U.S. Application Data
(60) Provisional application No. 61/543,214, filed on Oct. 4, 2011.

(51) Int. Cl. A01K 15/02

(52) U.S. Cl. 119/706; 119/702

(57) ABSTRACT

A musical scratching toy for pets is disclosed. The shape and decorative surfaces of the toy are designed to resemble a musical instrument or music-making device. Scratching elements are positioned on the toy, and are made from materials that are designed to encourage scratching behavior from pets. Electronic sensors are positioned underneath the scratching elements and are designed to detect scratching behavior. When an animal scratches the scratching surface of the toy, the sensors trigger pre-recorded, electronic musical output. In some embodiments, the toy includes a controller configured to select any number of styles of musical output.

### CROSS-REFERENCES TO RELATED APPLICATION

This application claims priority to U.S. Provisional Patent Application No. 61/543,214 filed on Oct. 4, 2011, entitled Musical Scratching Toy For Household Pets, the entire contents of which is incorporated herein by this reference.

### FIELD OF INVENTION

The present invention generally relates to toy products for household pets and, in particular, to an electronic music controller incorporated into a pet scratching product such as a scratching pad or post.

### BACKGROUND OF THE INVENTION

Known prior art of typical pet scratching products such as the scratching pad or post includes U.S. Pat. No. 5,592,901; U.S. Pat. No. 5,619,953; U.S. Pat. No. Des. 336,033; U.S. Pat. No. 4,907,540; U.S. Pat. No. 4,926,796; U.S. Pat. No. 5,775,263 and U.S. Pat. No. 6,343,569. However, the prior art scratching products do not offer a sensing architecture to detect the scratching behavior of the pet or to produce an entertaining response when the pet scratch. Also, none of the aforementioned patents disclose a scratching surface designed to both look like a musical instrument and to produce a musical output when scratched or rubbed upon by a pet.

Video games like Guitar Hero and Rock Band attempt to simulate the experience of playing in a rock and roll band. Though much of the intricacies of playing a real instrument are purposely removed, the simulation is strong enough to attract both musicians and non-musicians alike. Other toy instruments have been designed with similar goals in mind (for example, U.S. Pat. No. 20010003942 and U.S. Pat. No. 6,353,168). These designs have simple tactile controls and were created to help people of all ages and musical proficiencies experience some form of making music. Some have taken this idea to its extreme, and have considered ways to bring music making to all creatures, not just humans. Experimental artist Miya Masaoka, has made an interesting effort in this regard. Masaoka's artwork, “Pieces for Plants #6,” uses electrode signals from plants to drive MIDI synthesizers.

To date, no one has considered extending the Guitar Hero metaphor into the realm of household pet toys. Yet, people love watching their animals engage in anthropomorphic-seeming behaviors, and music making is no exception. A recent Youtube video, for example, shows a cat named Nora sitting upright in front of a piano and plunking notes repeatedly with her paws. While the assumption is that the cat is not intentionally making music, the illusion is powerful and engaging; indeed, the video has been viewed over three million times.

This invention creates a similar illusion of Nora the cat playing a musical instrument for any household pet with a basic propensity to scratch things. However, the invention does not require a prodigy cat like Nora to play the musical toy. Any cat or even a dog with a propensity to scratch or paw at this musical toy will enjoy hearing musical notes eminating from this inventive musical toy.

### SUMMARY OF THE INVENTION

The present invention is a musical scratching toy for household pets. The musical scratching toy for a pet comprises a predetermined shaped housing; a scratching surface mounted on the housing; an electronic sensor attached to the housing for detecting a pet scratching or rubbing on the scratching surface or for detecting the proximity of the pet to the housing to generate an output signal; and electronic circuitry including a speaker located within the housing and connected to the sensor output signal to trigger the speaker to play a predetermined sequence of musical notes corresponding to the pet scratching or the pet rubbing or the proximity of the pet to the housing.

Further, the musical toy invention comprises a predetermined shaped housing; an audio speaker attached to the housing a predetermined number of electronic sensors mounted on the housing for generating output signals of varying threshold values when activated by a pet action; a microcontroller within the housing for receiving and reading the values of each sensor output signal to provide a predetermined control output signal related to the read values of each sensor; a memory chip within the housing having pre-recorded audio stored therein for receiving the control output signal and for playing pre-recorded audio corresponding to the control output signal on the speaker.

Still further, the musical toy for pets, comprising: a guitar shaped body having a scratch surface along a portion of the body and a neck of the guitar; a piezo sensor connected within the body of the guitar below the scratch surface generating an output signal responsive to pet scratching of the scratch surface; a printed circuit board having pre-recorded playback audio segments and electronic components responsive to the sensor output signal to condition the piezo output signal for generating a trigger signal related to one of the pre-recorded playback audio segments; and a speaker responsive to the trigger signal for playing the one audio segment related thereto.

It is built to look like an instrument, and it provides predetermined musical sound like a musical instrument incorporating one or more predetermined musical sequences whenever it is scratched upon by a pet. Many pets exhibit scratching behavior, and there is therefore a large market to create scratching surfaces that appeal to pets. Scratching posts and pads come in a variety of colors, shapes, and sizes.

Portions of the physical structure of the disclosed invention are based on existing scratching products. Some embodiments resemble traditional scratching posts, and are built to stand vertically on a rectangular base. Others resemble scratching pads and are designed to either lay on the floor or be hung vertically on a wall or on the side of a piece of furniture. In all cases, the basic structure is modified so that it resembles an instrument of some kind. For instance, in one simple embodiment, a rectangular scratching pad is shaped to look like an electronic piano keyboard, with black and white keys painted down the length of the scratching surface. In another embodiment, the scratching post is designed to look like an electric guitar, with scratching twine attached in lieu of real guitar strings. Yet another embodiment resembles a DJ turntable, with the scratching surface designed to look like a record.

Electronic sensors positioned on the toy detect scratching behavior. When scratching behavior is detected, pre-recorded audio samples are played out of a built-in speaker, to heighten the illusion that the pet is actually playing an instrument. However, scratching behavior, per se, is not needed to trigger musical output. The invention can also trigger musical output whenever the scratching surface is rubbed against or stepped upon. Cats interact with scratching toys in a variety of ways, and this is not limited to scratching behavior. Different sensor platforms can be easily to tuned to detect any perturbation of the scratching surfaced (caused by scratching, rubbing, stepping, climbing, etc).

Proximity sensors could also be used to detect when an animal is close to the instrument. Combinations could also be employed. For instance, in a DJ scratch table embodiment, proximity sensors could trigger audio whenever the pet is close to the toy. Then, once the pet starts scratching or rubbing the toy, the audio could be interrupted with realistic DJ scratching sound effects.

The invention's form factor and electronic components are designed to appeal to both pets and pet-owners. Pets enjoy scratching on the toy, just as they would with any other scratching product. Pet owners enjoy the illusion the toy provides; when a pet scratches upon it, the pet appears to be playing an instrument and manipulating music.

### BRIEF DESCRIPTION OF THE DRAWINGS

FIG. 1 is a front view of an exemplary scratching toy.

FIG. 2 is a back view of the scratching toy depicted in FIG. 1.

FIG. 3. is a side view of the scratching toy depicted in FIG. 1.

FIG. 4. is a cross-sectional view of the scratching toy depicted in FIG. 1.

FIG. 5. is a circuit schematic for a preferred embodiment of the invention.

FIG. 6. is a block diagram that shows the connection architecture for a preferred embodiment of the invention.

FIG. 7. is a exploded perspective view of another guitar shaped pet scratching toy according to the present invention.

FIG. 8. is a perspective view of another scratching toy made in accordance with the present invention.

FIG. 9 is a flowchart diagram illustrating the control logic of the present invention.

### DETAILED DESCRIPTION

FIG. 1 is a front view of a preferred embodiment of a scratching toy 1a. In this embodiment, the toy 1a is shaped to resemble an electric guitar. Like traditional scratching products, this embodiment contains a scratching surface made from rough, scratchable material 1b, such as thick carpet, corrugated cardboard, twine, and the like. The scratching surface 1b is positioned along a guitar neck 1 and across the area that is designed to resemble a pickguard 2. This is done to purposely guide pets to scratch along specific regions of the toy. To heighten the illusion that the pet is playing the instrument, design elements encourage the pet to scratch portions of the instrument that are traditionally manipulated by human hands.

Non-functional decorative markings are used to make the toy appear like a guitar. These include faux pickups 7, a faux bridge 3, and faux strings 10. In some embodiments, strips of twine are secured down the length of the guitar neck 1 to create the appearance of guitar strings 10 and to provide an additional scratching texture. A speaker 8 is positioned inside the toy, and a speaker grill 4 is placed on the front of the toy. A single pole, single throw (SPST) logarithmic potentiometer 6 is also placed on the front of the toy. The switch component is used to turn the power on or off, while the knob is used to adjust the volume of the audio output. For this application, a logarithmic potentiometer is preferable to a linear potentiometer, because the former mimics the logarithmic response of the human ear and thus ensures that, for instance, a half a turn is perceptually the same as a half increment in volume.

A rotary switch 5 enables pet owners to select between different settings of audio playback. In one setting, a single music file is accessed from an ISD chip. If the output of the scratching sensors exceeds a pre-determined threshold, the audio file begins to play. The file starts from the beginning, and stops only if the sensors are idle for a predetermined threshold of scratching by the animal. If a sensor 14 continue to pass the threshold (that is, if the animal continues to scratch), the file continues to play and will loop back to the beginning when it has reached its end. Memory locations can also be set to record the audio buffer index when the audio has stopped. Then when the audio is triggered again, the toy resumes playback from an audio index recorded in a memory 20. This can enhance the musicality of the toy by ensuring that an audio clip stored in the memory 20 is not played from the exact same starting location over and over again.

In another setting, a collection of short musical clips is stored on the ISD chip 20. Anytime the sensors 14 detect scratching or perturbations along the guitar instrument 1a, one of these clips is chosen at random and played out the speaker 8. These clips can be different musical songs or different short musical phrases or notes. The latter, when strung together in random sequences, would give the impression that the pet is improvising on the instrument. To enhance musicality and to reduce dissonance, the pre-recorded notes are set to belong to the same musical scale. Further, in another setting, perturbations along the instrument or toy trigger two simultaneous audio streams. A pre-recorded rhythm track is played alongside random sequences of notes or phrases in the same musical key, giving the impression that the animal is improvising on top of an existing audio track.

Other settings selected from the rotary knob could specify different genres of audio playback (for example, rock, blues, country, or jazz clips could be accessed depending on the setting selected by the user).

In some embodiments, the invention employs an audio line-in jack and/or an external electret microphone. A memory card, such as a micro SD card, designed to hold audio files may also be incorporated into the memory chip 20. With these components connected to an ISD chip 20, the sound output does not have to be factory-installed and could in fact be customized and re-recorded by anyone at anytime. The rotary switch could be used to select this option.

The preferred embodiment contains several combinations of the aforementioned designs, allowing pet owners to select many different types of musical output just by moving the rotary switch. In addition, the current instantiation also offers three, higher-order playback modes: (1) strum mode, (2) riff mode, and (3) arena rock mode. These modes are not selected by the user, but are instead triggered automatically, depending on the sensor output. These higher-order modes can be used with any of the audio playback options described above.

To switch between these modes, a timer within a microcontroller 19 calculates the number of milliseconds between each successive scratch (the inter-scratch interval, or ISI). The ISI represents the frequency of perturbations, and the ISI is analyzed using time or frequency-domain techniques. If the ISI frequency is low, the toy is set to strum mode. For instance, if a pet rubs against the toy once, strum mode is engaged and the toy triggers a long, sustained chord. However, if multiple scratches are detected, with a short ISI between each, then the toy engages riff mode; musical notes and chords are played faster, to mimic the intensity of the pet's behavior.

Different audio modes are triggered depending on where the animal makes contact with the instrument. For example in one embodiment, the strum mode is triggered when perturbations are detected near the bottom of the instrument while riff mode is triggered when perturbations are detected near the top of the instrument. These changes are made irrespective of the intensity of frequency with which the instrument is being scratched or rubbed upon by the animal.

If the riff mode is activated continuously, for several seconds or longer, the toy switches to arena mode and crowd cheering sounds are played in conjunction with the musical output. Arena mode reflects many of the game mechanics that can be applied to this toy. While crowd sounds are used in the current instantiation, video game sounds could also be used. Points could also be displayed on the toy, to reflect the intensity and duration of a given pet's scratching behavior. For example, points are capable of being displayed numerically on a digital display or through different colors on an LED (with certain colors corresponding to different points values.)

An LED 8 positioned near the horn of the guitar is used to indicate the battery life of the toy. When the batteries are low, the light flashes or becomes dim, indicating that a battery replacement is needed. The LED could also be programmed to illuminate after a certain number of scratches have been detecting, thus alerting the owner that it is time to replace the scratching surface. Further, the LED could shine down onto the scratching surface, creating a moving target that incentivizes pets to interact with the toy.

The toy is positioned on top of a sturdy base 9. The base is heavy and wide and is designed to prevent the toy from toppling over when it is scratched upon.

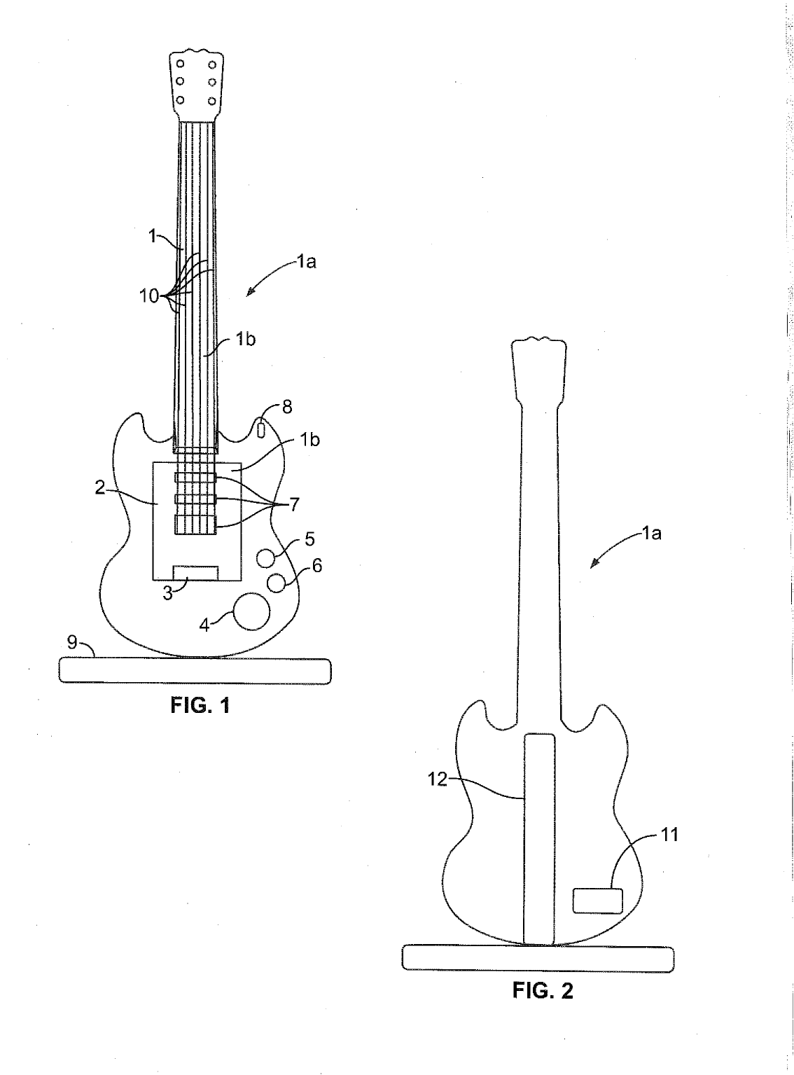

FIG. 2 is a back view of a preferred embodiment of the toy. A rectangular battery compartment 11 is positioned near the bottom of the instrument. A brace 12 is connected to the back of the toy. This brace is also connected to the rectangular base and is used to stabilize the toy.

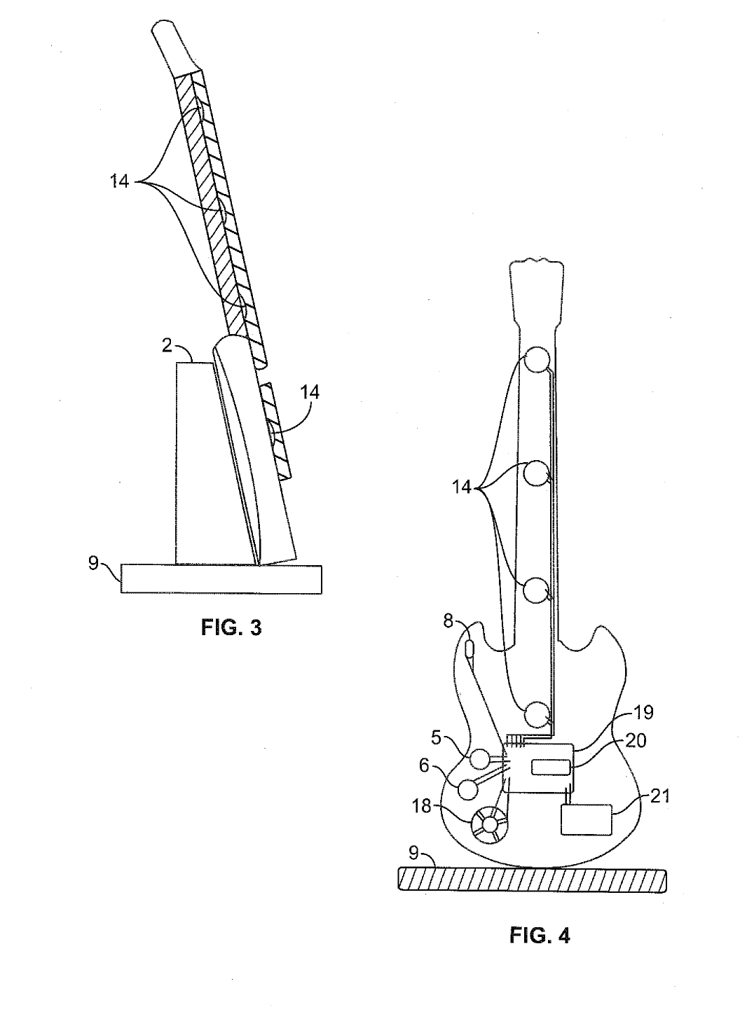

FIG. 3 is a side view of a preferred embodiment of the toy. Here, a side view of the brace 13 is shown. In this embodiment, the brace is angled, allowing the guitar frame to rest upon it at a slight angle. The scratching surface is also positioned at this angle, allowing pets to stretch even further as they scratch the instrument. Pets often engage in scratching behavior to sharpen or trim their nails, but they may also scratch in order to stretch their limbs.

Sensors 14 are positioned underneath the scratching surface. When the scratching material is scratched or rubbed against, the sensors generate a small voltage or create a change in electrical resistance. If the voltage value triggered from the sensors 14 passes a pre-defined threshold (i.e., if a scratch is detected by the sensors), a pre-recorded audio sample is triggered from an audio chip 20 and is played out of a built-in audio speaker 8. Alternatively, the sensors 14 are capable of being variable mechanical switches to reproduce the same effect as using electronic sensors 14. A typical embodiment uses piezoceramic disc sensors. These sensors are thin and can easily be positioned underneath the scratching surface. In this embodiment, several sensors are positioned along the neck of the guitar, and an additional sensor is positioned under the scratching surface near the faux pickups and faux bridge of the guitar. The positioning of these sensors may vary depending on the size of the toy, but preferred embodiments are designed to detect scratching at any location on the scratching surface. Other sensors (including but not limited to force-sensing resistors, button sensors, switches, motion sensors, proximity sensors or capacitive sensors) could also be employed to detect perturbations along the surface of the toy, and are within the scope of the present invention. Alternatively, a recessed photocell could be paced somewhere near the scratching surface, and could be used to trigger sounds simply when an animal is extremely close to the toy. Finally, microphone elements could be positioned within the body of toy and could be used to detect low frequency vibrations consistent with rubbing or scratching on the surface of the toy. Band-pass filters, band-stop filters, low-pass filters, high-pass filters or any combination thereof are employable with any of the sensors described above to preferentially pass sensor frequencies consistent with scratching, rubbing, climbing or other perturbations on the toy. Analog or digital components are used to filter the signal from the sensors to improve the sensing specificity, so that only behaviors of interest are detected.

FIG. 4 is a cross-sectional view of a preferred embodiment, as seen from the back of the toy. The analog signals from the four sensors 15 are sent to separate analog inputs in a microcontroller unit 19. The microcontroller is capable of being a microprocessor, an Application Specific Integrated Chip, components on a printed circuit board or other discrete components either digital or analog to process the output signals from the sensor. In this embodiment, the microcontroller 19 reads the values from all the sensors 14, and if the sum of all the values exceeds a pre-determined threshold, pre-recorded audio is retrieved from a memory chip 20 and played out of the speaker 18. In other embodiments, different audio tracks could be played depending upon which sensor is most active (in other words, depending on where the pet happens to be scratching the instrument). Also, different features of the audio playback could be adjusted in real time, depending upon the intensity of the sensor output. For example, in some playback settings, the audio volume could be linked to the output level of the sensors (and, in turn, the intensity with which a pet is scratching the toy). This would enable pets to create dynamic changes in certain features of the audio. While changing the volume of the audio is an obvious example, other features could be manipulated as well. For example, the initial transients of a note could be adjusted depending on the output level of the sensors. If the sensor output is high, the playback could contain a lot of accented, staccato notes. Conversely, if the sensor output is just barely above the detectable threshold, then the audio playback could feature soft, legato notes.

The battery compartment 11, the rotary knob 5, the SPST potentiometer 6, and the LED 8, described previously, can all be seen in this cross-sectional view. All the electronic components of the preferred embodiment are contained within the toy, and are protected from the pets. Preferred embodiments enclose the electrical components in a sealed plastic shell that cannot be penetrated or damaged, even if scratched upon by a pet with sharp nails or claws. In other embodiments, the shell of the toy may be fabricated with any suitable material, or combination of materials, such as wood, cardboard, or the like.

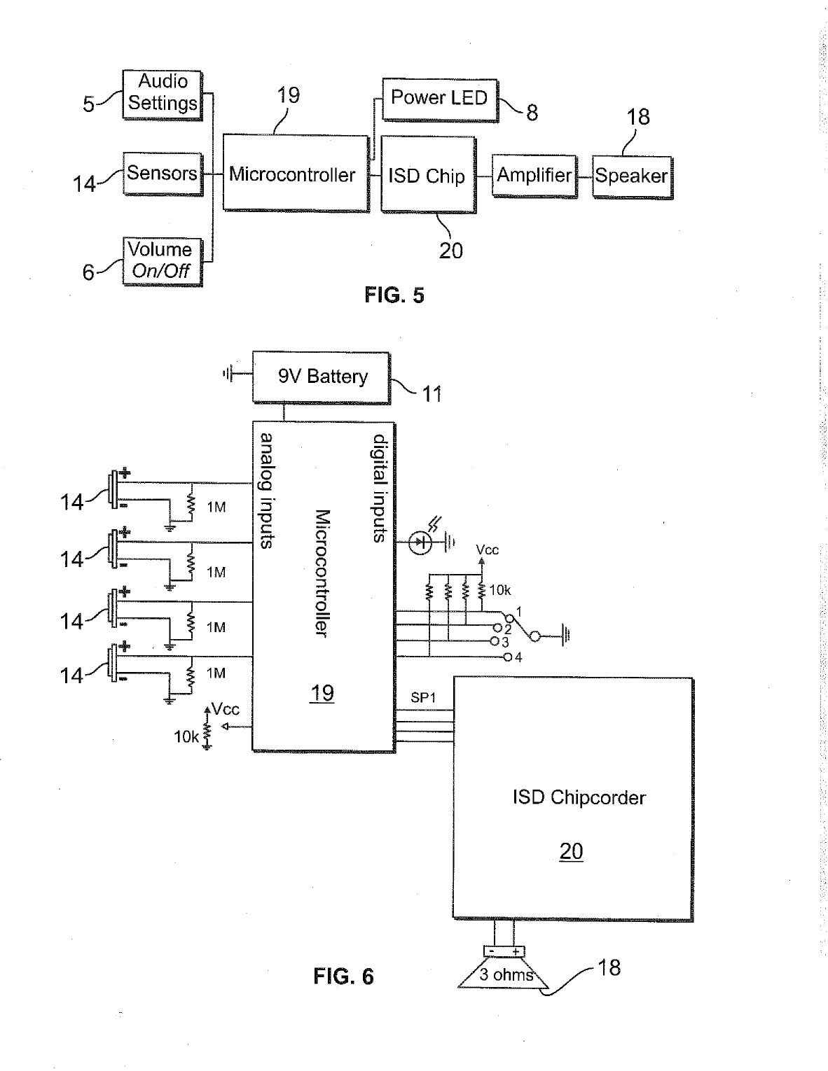

FIG. 5 is a block diagram of the main electrical components of the scratching toy. The microcontroller receives data from three sources: 1) the settings controller, which can be used to specify different types of audio output; 2) the analog sensors, which are used to detect scratching behavior; and 3) the volume and on/off controls.

Communication between the microcontroller and the ISD chip is achieved through the Serial Peripheral Interface (SPI) protocol. This enables code from the microcontroller to access stored audio data within different memory slots of the ISD chip. Audio data is passed through a D/A converter on the ISD chip and is sent to an audio amplifier. The amplifier boosts the analog audio signal and sends it to an external speaker for playback.

FIG. 6 shows a circuit schematic for a preferred embodiment of the invention. Four piezo sensors 14 are connected to the analog inputs of a microcontroller unit. A 1M resistor is connected to ground between each sensor, in order to bleed off excess voltage when the sensor is activated.

A rotary switch 5 is connected to the microcontroller's digital inputs and is used to select different audio output options. Each lead of the switch 5 is configured as a pull-up resistor, and is connected to Vcc through a 10K resistor.

The entire circuitry of the toy is powered with a 9 volt battery 11, which, when passed through a voltage regulator on the microcontroller, provides a stable source of 5 volts.

The LED 8 is connected to the PWM output of the microcontroller 19. This LED can be programmed to blink on and off when the battery power is low, and it can also be used to indicate when the device is turned on or off. Another embodiment could include multiple LEDs that could light up whenever the scratching is detected, thus providing an entertaining visual response to complement the audio response.

The microcontroller is connected to an ISD chipcorder 20, which handles audio storage, audio playback, and audio amplification. Different audio selections can be triggered through SPI commands from the microcontroller. For instance, the microcontroller unit could be programmed to send out a play command whenever one of the piezo sensors exceeds a certain voltage threshold. Once triggered, the audio signal is sent to a speaker component for playback.

For simple instantiations of this invention, microcontrollers are not necessary. Instead, analog circuitry and integrated circuits can be used to control the ISD chip. For instance, while a microcontroller could be programmed to detect extreme changes in sensor output, this can also be done with a Schmitt trigger. A Schmitt trigger can be used to detect whether the sensors' analog outputs exceed thresholds associated with scratching or rubbing behavior. Transistors, Timer ICs, and other integrated circuits can be used to supplant much of the control logic that might otherwise be relegated to a microcontroller unit. These are just a few examples of how to trigger sounds without using a dedicated microcontroller, but there are many other methods known in the industry and they are within the scope of this invention.

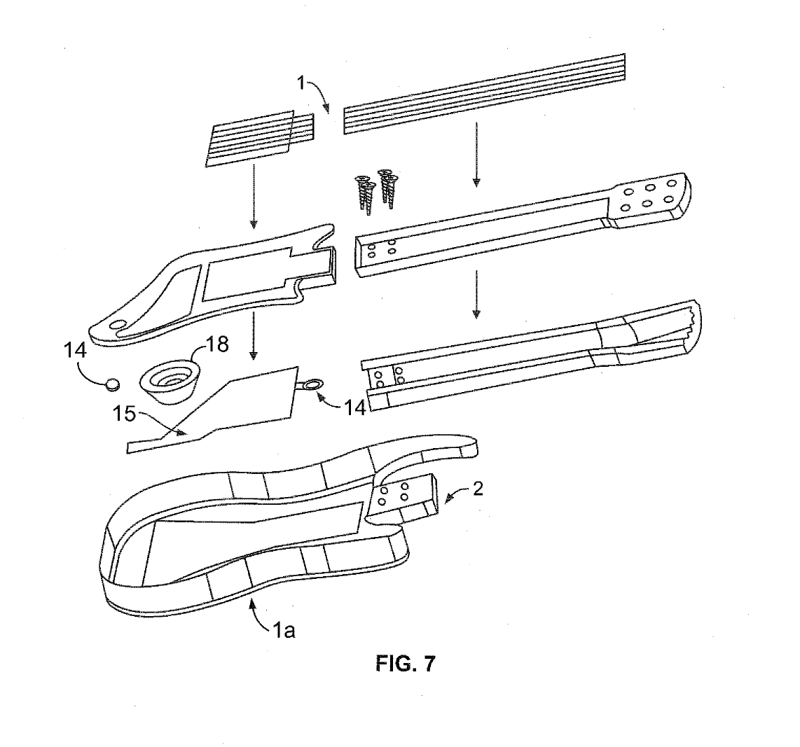

Turning now to FIG. 7, an alternative configuration for the guitar musical toy that includes a detachable neck 1 of the guitar for replacement of scratching material 1b. The neck 1 is inserted into a pre-routed pocket 2 within the housing or body of the guitar 1a. A piezo sensor 14 on the left side of FIG. 7 or to the right as sensor 14 are located on a printed circuit board 15 with digital or analog components for processing the output signals from the sensors 14 and trigger the desired audio output. The speaker 18 is driven by the circuitry on the printed circuit board 15 which processes the output signal from the sensors 14. The sensor is positioned flush against an interior plastic surface of a top portion of the guitar. Screws are used to attach the neck of the instrument to the housing the pre-routed pocket on the housing or body. This configuration has all of the components housed within the body of the instrument or musical toy.

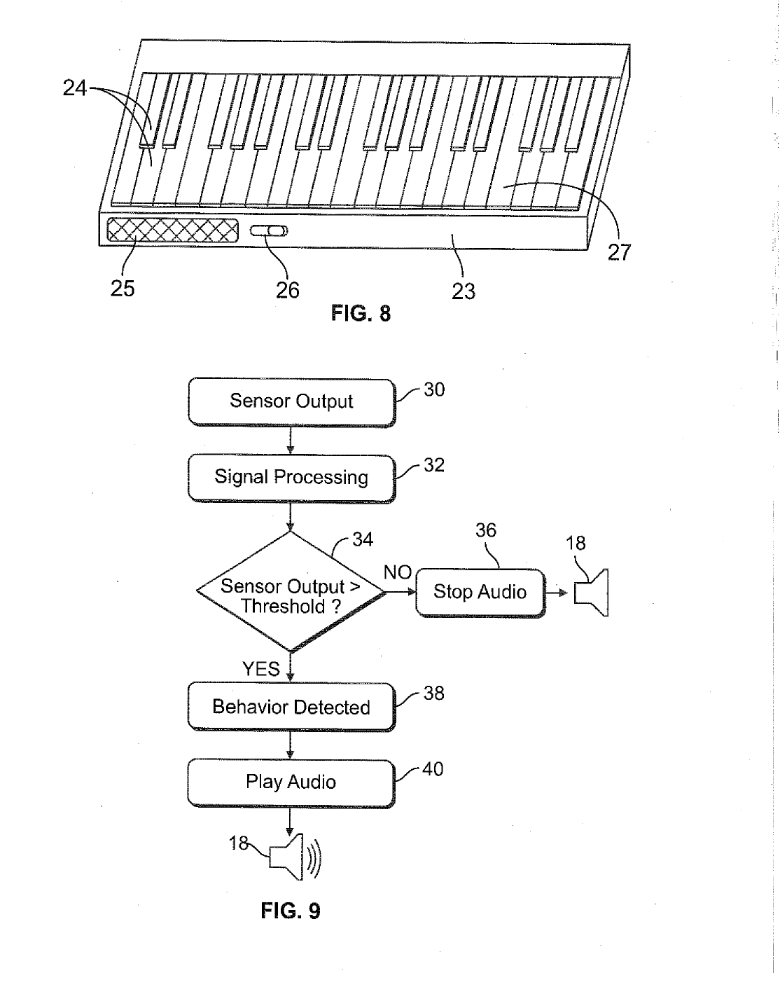

FIG. 8 shows a front view of another embodiment of the toy. The structural frame of this embodiment is not modeled after a vertical scratching post, as in the embodiment depicted in FIGS. 1-4. Instead, it is modeled after scratching pads that are meant to lie flat on the ground. The scratching surface is placed on the top side of the scratching pad 27. Decorative markings are applied to the scratching surface to make it look like a piano keyboard 24. As with all embodiments of this invention, the scratching surface can constructed from any number of suitable materials, such as twine, thick carpet, or corrugated cardboard.

The electronics are enclosed within the toy, and a speaker is placed along the front edge 23 and is covered with a speaker grill 25. A power on/off switch 26 is also placed on the front edge.

FIG. 9 is a flowchart diagram illustrating the control logic of one embodiment of the invention. First, the sensor signal is filtered to pass frequencies consistent with behaviors of interest (e.g., scratching, rubbing, climbing or otherwise manipulating the toy). If a filtered sensor output 30 exceeds a pre-determined threshold consistent with scratching, rubbing, climbing, or another behavior of interest, pre-recorded audio is played from a memory chip through a speaker 18. This decision can be based on switch sensors that employ binary logic or on analog sensors that output a range of values. The threshold can be defined as a single, pre-determined sensor value or it can be defined as an average value computed across a pre-determined time window. Further, the threshold could be defined as a pre-determined number of zero-crossings observed across a pre-determined time window. Further still, the threshold could be defined as the sensor frequency observed in frequency-domain analyses across a pre-determined time window. The slope, the first-derivative, or the second-derivative of the signal can also be used to compute a threshold. Still other analyses based in time or frequency-domains can be used to compute threshold detection and are within the scope of the invention described herein.

Further, FIG. 9 shows the sensor output signal 30 is connected to the Microcontroller 19 that does a Signal Processing 32. Then a Sensor Output Threshold logic block 34 has two logic outputs of Yes? or No?. If the threshold of the processed signal is not greater than a predetermined level or NO logic, a stop audio logic block 36 stops the audio output to speaker 18. If the threshold of the processed signal is greater than a predetermined level or YES logic, then the processed signal is sent to a Behavior Detected logic Block 38 that then feeds a Play Audio logic Block to generate a predetermined musical selection from pre-recorded clips in memory 20 through the speaker 18.

While several embodiments of this invention have been described, it will be clear to those skilled in the art that many additional modifications are possible without departing from the scope of the invention described herein.

Having thus described the invention, we claim:

1. The musical scratching toy for a pet comprising:
a predetermined shaped housing;
a scratching surface mounted on the housing;
a sensor attached to the housing for detecting a pet scratching or rubbing on the scratching surface or for detecting the proximity of the pet to the housing to generate an output signal; and
electronic circuitry including a speaker located within the housing and connected to the sensor output signal to trigger the speaker to play a predetermined sequence of music corresponding to pet scratching or rubbing or to the proximity of the pet to the housing.

2. The musical scratching toy of claim 1, wherein the housing is shaped like a electronic piano keyboard having a rectangular scratching surface representing piano keys.

3. The musical scratching toy of claim 1, wherein the housing is shaped like an electric guitar having a scratching surface representing guitar strings.

4. The musical scratching toy of claim 1, wherein the housing is shaped like a DJ turntable having a scratching surface representing a record being played on the DJ turntable.

5. The musical scratching toy of claim 1, wherein the scratching surface is a thick carpet or a corrugated cardboard or twine or other similar scratching material.

6. The musical scratching toy of claim 2, wherein the electronic sensor is located beneath the piano keys scratching surface.

7. The musical scratching toy of claim 3, wherein the electronic sensor is located beneath the guitar string scratching surface.

8. The musical scratching toy of claim 4, wherein the electronic sensor is located beneath the record scratching surface.

9. A musical toy comprising:
a predetermined shaped housing;
an audio speaker attached to the housing
a predetermined number of electronic sensors mounted on the housing for generating output signals of varying threshold values when activated by a pet action;
a microcontroller within the housing for receiving and reading the values of each sensor output signal to provide a predetermined control output signal related to the read values of each sensor;
a memory chip within the housing having pre-recorded audio stored therein for receiving the control output signal and for playing pre-recorded audio corresponding to the control output signal on the speaker.

10. The musical toy of claim 9, further including an audio settings switch and a volume on/off switch attached to the housing providing inputs to the microcontroller.

11. The musical toy of claim 9, further including a battery source connected to the microcontroller to power the sensors, microcontroller, ISD chip and speaker.

12. The musical toy of claim 9, wherein the sensors are piezo sensors.

13. The musical toy of claim 10, wherein the audio settings switch is a rotary switch connected to the microcontroller digital inputs to select different audio output musical selections.

14. The musical toy of claim 1, wherein the memory chip is an ISD chipcorder having a storage location for the pre-recorded audio, an audio playback and an audio amplification for the speaker.

15. A musical toy activated by pet action, comprising:
a housing;
an electronic sensor mounted on the housing for detecting the pet action and generating an output signal proportional to the pet action;
an electronic controller connected to the sensor for receiving the sensor output signal and for generating a control signal related to the sensor output signal;
a memory chip connected to the controller having a predetermined number of pre-recorded audio playback segments stored thereon for selecting one of the predetermined number of pre-recorded audio playback segments corresponding to the generated control signal from the controller; and
a speaker connected to the memory chip for playback of the selected pre-recorded audio.

16. The musical toy activated by pet action of claim 15, wherein the housing is in the shape of various musical instruments.

17. The musical toy activated by pet action of claim 15, wherein the electronic controller is an analog circuitry or an integrated circuit or an ASIC having a voltage regulator for connection to a battery power source to power the sensor, controller, memory chip and speaker.

18. The musical toy activated by pet action of claim 15, wherein the memory chip is an ISD chipcorder circuit for driving the pre-recorded audio playback through the speaker.

19. A musical toy for pets, comprising:
a guitar shaped body having a scratch surface along a portion of the body and a neck of the guitar;
a piezo sensor connected within the body of the guitar below the scratch surface generating an output signal responsive to pet scratching of the scratch surface;
a printed circuit board having pre-recorded playback audio segments and electronic components responsive to the sensor output signal to condition the piezo output signal for generating a trigger signal related to one of the pre-recorded playback audio segments; and
a speaker responsive to the trigger signal for playing the one audio segment related thereto.

20. The musical toy for pets of claim 19, wherein the neck of the guitar is inserted into a pre-routed pocket within the body and affixed by screws.

21. A musical toy for pets, comprising:
a housing;
a scratch surface on the housing;
a sensor attached to the housing for detecting the pet action on the scratch surface or with regard to the housing and for generating an output signal proportional to the pet action;
a band-pass filter for creating a filtered output signal from the sensor output signal;
a controller connected to the band-pass filter for processing the filtered output signal to generate a control signal corresponding to a threshold defined as a single, pre-determined sensor value or defined as an average value computed across a pre-determined time window related to the filtered output signal above a predetermined threshold;
a memory chip connected to the controller having a predetermined number of pre-recorded audio playback segments stored thereon for selecting one of the predetermined number of pre-recorded audio playback segments corresponding to the generated control signal from the controller; and
a speaker connected to the memory chip for playback of the selected pre-recorded audio.

22. The musical toy for pets of claim 21, wherein the pre-recorded audio segments are mapped to the intensity or frequency of the filtered output sensor signal created by the behaviors of interest by the pets.

23. The musical toy for pets of claim 21, wherein the controller is a digital or analog circuit.

24. The musical toy for pets of claim 21, wherein the band-pass filter, controller and memory are located on a printed circuit board having digital or analog circuitry for driving the speaker with a pre-recorded audio related to the behavior of the pet with the toy.
